(19) United States
(12) Patent Application Publication
(10) Pub. No.: US 2009/0178296 A1
(43) Pub. Date: Jul. 16, 2009

(54) Apparatus and method for drying containers for beverages

(75) Inventors: Bernhard Duenzinger, Unterdeggenbach (DE); Tobias Eichhammer, Bad Abbach (DE); Rudolf Fiegler, Regensburg (DE)

Correspondence Address: SIMPSON & SIMPSON, PLLC, 5555 MAIN STREET, WILLIAMSVILLE, NY, 14221-5406, US

(73) Assignee: KRONES AG, Neutraubling (DE)

(21) Appl. No.: 12/321,100

(22) Filed: Jan. 15, 2009

(30) Foreign Application Priority Data
Jan. 16, 2008 (DE) 10 2008 004 774.0

(51) Int. Cl. F26B 5/00; F26B 19/00; F26B 25/06

(52) U.S. Cl. 34/413; 34/90; 34/201

(57) ABSTRACT

An apparatus and a method for drying articles are disclosed. The apparatus includes a closed housing with at least one chamber equipped with air nozzles. The apparatus has an inlet opening and an outlet opening for the articles to be dried. An inner routing of air flow inside the housing generates a defined removal of air to the at least one air outlet opening. The inner routing of air flow is designed such that a flow of air is directed past the inlet opening and/or the outlet opening for the articles to be dried.

### CROSS REFERENCE TO RELATED APPLICATIONS

This application claims priority of German Patent Application No. 10 2008 004 774.0, filed on Jan. 16, 2008, which application is incorporated herein by reference.

### FIELD OF THE INVENTION

The present invention relates to an apparatus for drying containers for beverages. In addition, the invention relates to a method for drying containers for beverages.

### BACKGROUND OF THE INVENTION

Normally, certain humidity prevails with apparatuses for filling and labelling of bottles, and the humidity adheres to the exterior surface of the bottles after the filling process. Traces of liquid can also remain on the interior surface and/or exterior surface of the bottles after the bottles had been washed.

During optical inspection of the bottles for mechanic intactness and/or the existence of foreign particles, such as impurities or bits of broken glass for example, such remaining traces of liquid in the form of drops can considerably limit the optical image quality. Therefore it is advantageous to subject bottles for optical inspection which are as dry as possible.

Apparatuses for drying bottles, as known from the state of the art, comprise one or more consecutively arranged box-shaped chambers, whereby a conveyor belt with upright standing bottles is routed through. Inside the chamber, a plurality of air nozzles are blowing off remaining liquid adhering to the exterior surface of the bottles and guarantee thereby that dry bottles are leaving the apparatus for drying articles. The amount of air needed for drying is provided by a high-capacity blower which intakes outer air and routes it to the nozzles. Excess pressure prevailing within the particular chambers of the apparatus for drying articles can exhaust by means of a plurality of openings, particularly through the opening for the bottle supply and the opening for the bottle removal which are defined by the position of the conveyor belt. Since a significant amount of air is required for feeding the air nozzles, excess pressure exhausts with relatively high air speed. The exhausting air and the fast-running blower cause a significant generation of noise.

### SUMMARY OF THE INVENTION

The object of the invention is to reduce the acoustic emissions produced by an apparatus for drying articles such as containers for beverages and bottles.

This object of the invention is achieved by an apparatus for drying articles. The invention is particularly designed as an apparatus for drying articles, wherein the articles are bottles. The apparatus comprises a largely closed housing with at least one chamber. For drying the articles and bottles respectively, the articles or bottles are being transported on a conveyor belt through the housing and subjected to compressed air and rapid accelerated air respectively within the housing. Inlet openings and outlet openings are provided for the conveyor belt with the bottles or other articles to be transported on it. Furthermore, at least one air inlet opening for the supply of drying air and at least one air outlet opening for discharging the drying air out of the housing are provided. According to the present invention, an inner routing of air flow inside the housing is formed for generating a defined removal of air to the at least one air outlet opening. The inner routing of air flow has a flow which is directed past the inlet opening and/or the outlet opening for the articles to be dried. The directed air flow provides that as little air as possible leaks through the inlet opening and the outlet opening, so that in this way the airborne sound, which is transported through the inlet opening and the outlet opening, is being reduced considerably.

Another object of the invention is to provide a method which reduces the acoustic emissions produced by an apparatus for drying articles such as containers for beverages and bottles.

The method for drying articles, particularly containers of beverages such as bottles or the like, provides air nozzles which are blowing at the articles to be dried inside of a largely closed housing. Drying air is being supplied via at least one air inlet opening and the air is being discharged again via at least one air outlet opening out of the housing. According to the present invention, a defined removal of air to the at least one air outlet opening is generated by means of an inner routing of air flow inside the housing, wherein the exhaust air is basically directed past an inlet opening and/or outlet opening for the articles to be dried. In this way it is avoided that air from the inlet openings and outlet openings for conveying the articles is discharged uncontrolled through the housing, and that thereby all sound absorbing features are considerably facilitated due to the immediate influence on the relevant sound sources. According to a preferred embodiment of the method according to the invention, the exhaust air is routed through at least one outlet opening being formed as a sound absorbing air discharge duct.

According to a preferred embodiment of the invention, the at least one air outlet opening is formed as an air discharge duct, through which the air of the blower is being discharged. When the air discharge duct is formed in such a way, well directed sound absorbing features can be intended for. Furthermore, effective sound absorption can be realised with relatively low constructional effort. As a result, the air discharge duct can be particularly formed as a reflexion and/or as an absorption silencer. For this purpose, sound absorbing elements can be arranged in the air discharge duct. The absorbing elements can be basically almost any embodiments, as known and available in the field of machine acoustics. The arrangement of at least one structured plate with metal wool as an absorbing element, wherein the structured plate is arranged inclined to the longitudinal direction, could be particularly simple and inexpensive. Alternatively, two or more suchlike structured plates, which are arranged inclined to the longitudinal direction, can be arranged consecutively in the air discharge duct. The sound is being partially absorbed and partially reflected at this structured plates, wherein the sound is being scattered excessively.

The sound absorption can be supported by means of lining the inner walls of the air discharge duct with sound absorbing material and/or providing structured inner walls of the air discharge duct. As for structured plates, mesh surfaces with large mesh sizes with metal wool or mineral wool being arranged behind the mesh surfaces can be used, for example. Stainless steel wool is particularly suitable as sound absorbing material, since no nameable corrosion occurs, so that also high hygienic requirements are fulfilled during permanent operation.

The air flow running through the air discharge duct can be supported by means of additional fans which optionally either blow or exhaust. It is an advantageous embodiment to provide an sucking fan at the outer mouth of the air discharge duct which can additionally support the defined routing of air flow within the housing by means of its undertow effect.

According to another embodiment of the present invention, blowing nozzles which are geared to the air discharge duct can be arranged within the housing near by the inlet opening and/or the outlet opening for the articles to be dried. These blowing nozzles can be directed inclined upwards on both sides of the conveyor belt. Preferably, the blowing nozzles are arranged nearby and underneath the air discharge duct respectively, so that the air flow running through the housing and in direction of the air discharge duct is predetermined by the airflow of these nozzles as well as by the undertow being generated by the additional fan as the case may be. Ideally, only a very small portion of drying air is being discharged from the inlet openings and the outlet openings when using the above-mentioned arrangement, so that the effort regarding sound absorbing features can be kept low at these positions.

In addition, the housing can be provided with elements for air sound absorption and/or body sound absorption, for example in the shape of insulating mats at the interior surfaces of the housing. Preferably, all openings of the housing which are not necessary for the air flow, such as clearances at flaps or lids, are sealed. The additional insulating mats can both reduce body sound oscillation and provide the sound radiation of the housing surfaces being reduced.

A particularly advantageous embodiment of the apparatus according to the invention is a modular assembly having a plurality of consecutively arranged drying modules, which are connected with each other. The smallest unit is formed by one single module having an inlet opening as well as an outlet opening for the articles to be dried, such as bottles. Within the housing, at least one air nozzle arrangement is provided for blowing off the articles. Besides, an air supply and an air discharge opening are necessary. Alternatively, a plurality of further modules, having different or identical air nozzle arrangements and apart from that a largely same assembly, can be connected with this one single module.

In this way, a first drying module with the inlet opening for the articles and bottles respectively and with nozzles for a drying of a lateral area of the articles and/or of a bottle neck can be provided. A second drying module being connected with foresaid first drying module in feeding direction of the articles can be provided, for example, with nozzles for drying the bottom of the articles and/or the bottom of the bottle. A third drying module being connected with the foresaid second drying module in feeding direction of the articles can be provided both with the outlet opening for the articles to be dried and with further nozzles for drying the lateral area and/or the bottle neck. As a matter of course, apparatuses with only two drying modules or also with four drying modules or more drying modules are possible depending on the drying effort which is necessary and reasonable in the particular application.

As for hygienic requirements during the filling process and as for the permanent humid atmosphere, it is reasonable if the elements of the apparatus for drying articles are basically of corrosion-resistant material. For this purpose, stainless steel is particularly suitable. Alternatively, non-metallic elements can also be used.

A preferred embodiment of the invention provides at least one air flow generator which is formed by means of a blower being arranged inside the housing or at the housing. Such blower can be provided with particularly one electric driving motor and an axial conveyor or radial conveyor, which is preferably provided with an air intake filter and/or an intake silencer. If necessary, the power of the blower can be adjusted variably. In order to balance the losses caused by an air intake filter, which is no longer fully transmissible, it can be reasonable to detect the decrease of pressure caused by the decreasing filter transmissibility by means of a suitable sensor in the air feed pipe after the blower and to balance the decreasing transmissibility by means of an increased power of the blower. As soon as the power of the blower reaches a maximal value after having been running for a long time, the necessity of changing or cleaning the air intake filter can be displayed.

Alternatively, the air flow generator can be arranged separately from the apparatus for drying articles and be connected with the apparatus for drying articles via an air feed pipe. This can be then of advantage, when a central air supply for a plurality of modules or a plurality of apparatuses for drying articles can be reverted to. This alternative, however, can also be advantageous regarding an even better noise reduction, since with all sound insulating features the sound proportions of the blower and its driving motor as well as of the intake noise do not have to be taken into consideration anymore. Basically, only the noise development of the air emanating from the drying nozzles as well as the airborne sound of the air being discharging from the housing is to be taken into consideration.

Further sound absorption can be achieved by positioning the outlet air silencer separately from the housing and connecting the outlet air silencer with the housing via an air outlet feed pipe.

In another embodiment of the method, the blowing nozzles, which are positioned within the housing near by the inlet opening and the outlet opening for the articles, can provide exhaust air to be geared to the air discharge duct. The air flow is preferably being generated by means of a blower which is positioned either inside the housing or at the housing.

Alternatively, the drying air can be supplied, however, also from the outside via an air feed pipe.

Another embodiment of the method comprises the step of detecting a delivery pressure or a delivery volume within the air feed pipe after the blower. In this way, a varying delivery pressure of the blower can be counteracted by adjusting the power of the blower. The delivery pressure can, for example, decrease due to a decreasing transmissibility of the increasingly clogged air intake filter. By increasing the rotational speed of the blower motor, the capacity of the blower can be kept constant as long as the maximal output of the driving motor is reached.

### BRIEF DESCRIPTION OF THE DRAWINGS

Further features, objects and advantages of the present invention will now be explained in greater detail in the following description which should not be regarded as limiting the invention and which refers to the accompanying figures. Same reference numbers refer to same elements throughout the various figures and are not explained repeatedly.

FIG. 1 shows a perspective view of an apparatus for drying articles consisting of three drying modules connected with each other.

FIG. 2 shows a perspective cutted view along the longitudinal axes of the apparatus for drying articles according to FIG. 1.

FIG. 3 shows a detailed view of a first drying module of the apparatus for drying articles.

FIG. 4 shows an air discharge duct of the drying module, whereby the air discharge duct is formed as a sound silencer.

FIG. 5 shows a top view on the air discharge duct.

FIG. 6 shows the direction of the air flow within a drying module.

### DETAILED DESCRIPTION OF THE INVENTION

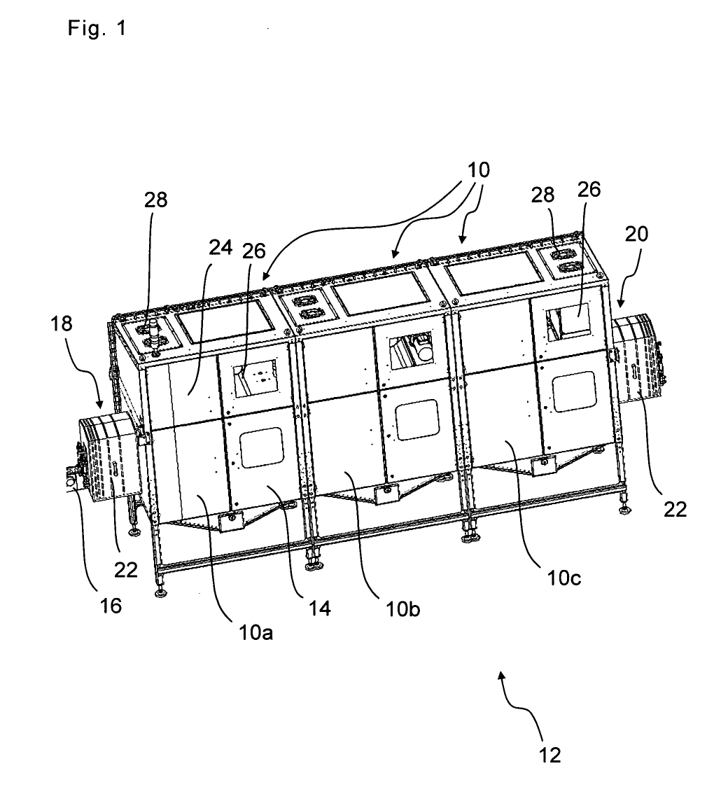

The schematic view of FIG. 1 shows a perspective view of an apparatus 12 for drying articles consisting of three drying modules 10 connected with each other, which can serve in the present embodiment particularly for drying bottles after they had been filled and capped. The drying modules 10 form a common housing 14 of the apparatus 12 for drying articles, since the walls are missing on their sides pointing to each other. A conveyor belt 16 runs through the apparatus 12 for drying articles, and upright standing bottles are being transported onto the conveyor belt 16 through the apparatus 12 for drying articles. For this purpose, the first drying module 10a is provided with an inlet opening 18 for the conveyor belt 16 with the bottles, which are arranged on the side wall remote from the second drying module 10b. In the same way, the third drying module 10c is provided with an outlet opening 20 for the conveyor belt 16, whereby the outlet opening 20 is also arranged on the side wall remote from the second drying module 10b. Both the inlet opening 18 and the outlet opening 20 are formed as attached air locks 22 which provide by means of their interior assembly that only little air can leak from the inside of the housing of the apparatus 12 for drying articles through the openings 18 and 20. In addition, this function as an air lock 22 as well as the sound absorbing design of the air locks 22 provides that only very slight noise emissions emanate from the openings 18 and 20. The remaining walls 24 of the drying modules 10 are of firmly assembled and pivoted plates which can be preferably lined on the inside with sound absorbing material such as bitumen mats or the like. The front walls 24 can particularly be formed as pivoting doors, through which the inside of the housing can be quickly accessed.

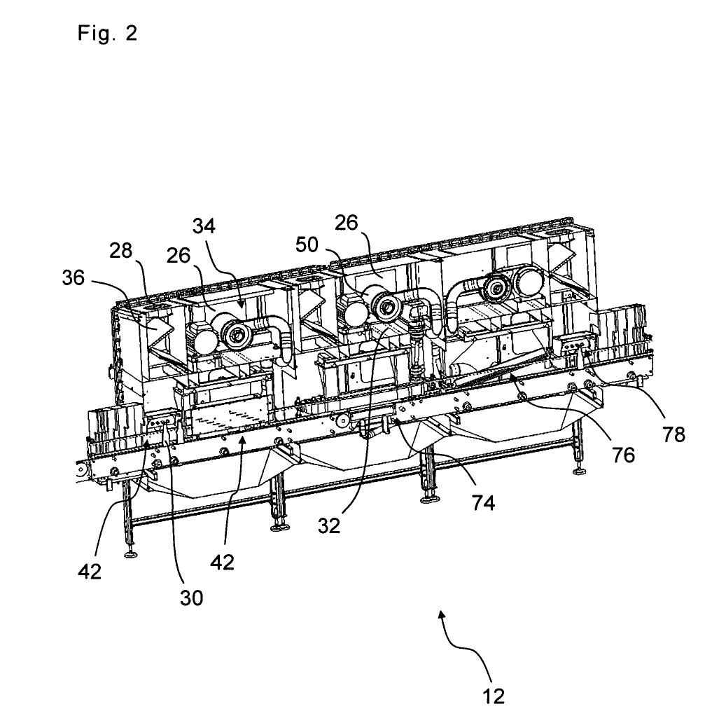

The upper part of the housing of each drying module 10 is formed as an air flow generator having an air inlet opening 26 positioned at an upper side wall and air outlet openings 28 positioned at the top of the housing. The in-coming drying air from the inlet opening 26 is being routed to the drying nozzles nearby the conveyor belt 16 with the bottles standing upright on it by means of an electromotive blower (see FIG. 2) and air feed pipes, and being routed again to the outside through the outlet openings 28.

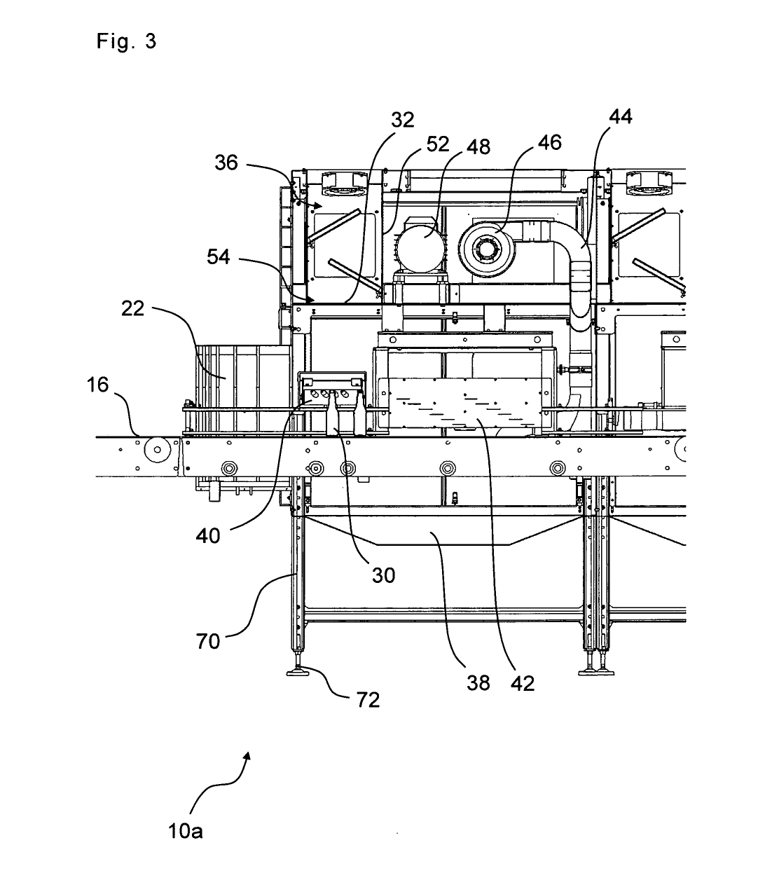

The schematic view of FIG. 2 shows a perspective longitudinal cut of the apparatus 12 for drying articles for drying bottles 30 which are being transported on the conveyor belt 16. Hereby it is recognisable that each of the shown drying modules 10a, 10b and 10c is basically provided with three housing segments. In the middle housing segment, the conveyor belt 16 as well as the nozzles (see FIG. 3) for blowing off the bottles 30 are situated. A funnel shaped or tray shaped water outflow as well as, if necessary, a siphon for sound insulation at the deepest position of the middle housing segment are provided on the bottom. The dripping and/or draining water from the bottles or from other parts of the drying module 10 are being here gathered and carried off.

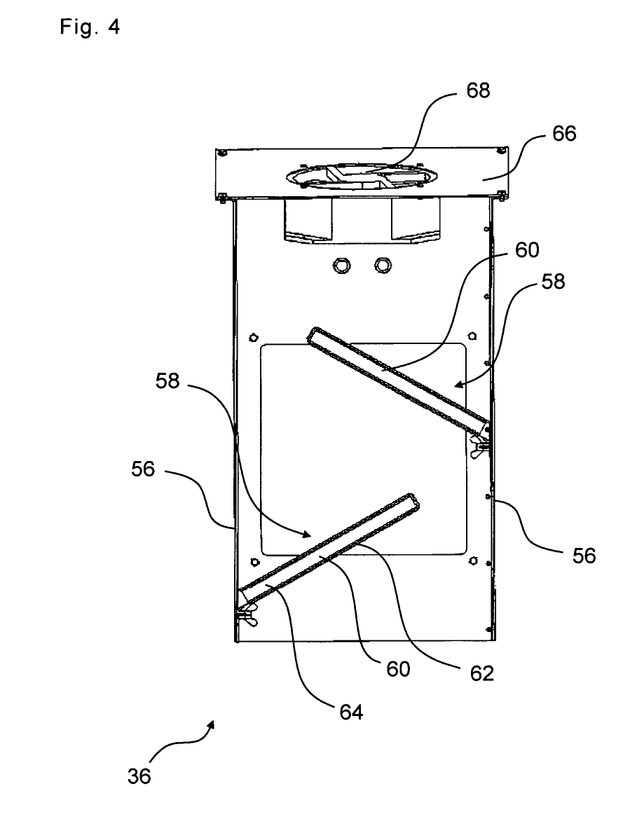

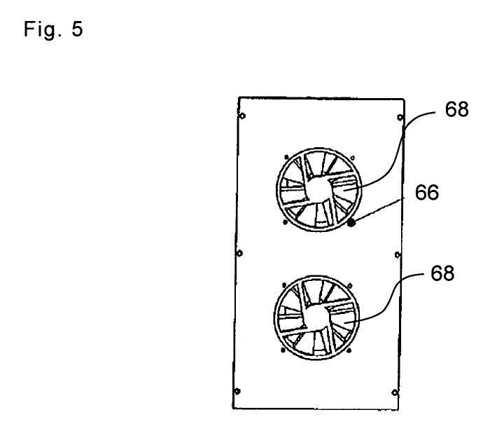

The air inlet opening 26, an air flow generator as well as an air discharge duct 36 which is routed to the air outlet opening 28 are positioned above the middle segment and separated by a horizontal separating plate 32. The air discharge duct 36 having the form of a sound silencer is being described in more detail on the basis of FIGS. 4 and 5.

The detailed view of FIG. 3 shows the first drying module 10a of the apparatus for drying articles 12 with its substantial elements. The tray 38 which is positioned underneath the conveyor belt 16 gathers the water and carries off the water if necessary via a sound absorbing labyrinth pipe (not shown) and a siphon respectively. Directly past the inlet opening 18 and the air lock 22 shielding the inlet opening 18, a first air nozzle arrangement 40 is positioned in the shape of four pairs of circular nozzles inclined upwards which are directed onto the bottle 30 neck part and are upwards blowing off the bottles 30. The circular nozzles of the first air nozzle arrangement 40 are each on both sides positioned on the conveyor belt 16. Preferably, both the distance between the circular nozzles and the conveyor belt 16, and the vertical position of the circular nozzles and/or the blowing angle can be varied in order to allow different widths of the conveyor belt 16 and likewise different sizes, i.e. different bottle widths and bottle heights. Past the first air nozzle arrangement 40 a second air nozzle arrangement 42 follows in the shape of gradually arranged flat extrusion nozzles which are consecutively arranged among each other in the feeding direction of the bottles 30. Two of those discharging areas are arranged opposing to each other on both sides of the conveyor belt 16. The second air nozzle arrangement 42 is also preferably adjustable in its respective distance to the conveyor belt 16 as well as in its incline and/or height if necessary.

Both air nozzle arrangements 40 and 42 are being fed via air feed pipes 44 from the air flow generator 34 which is positioned above the horizontal separating plate 32, whereby the air flow generator 34 comprises an axial blower 46 as well as an electric driving motor 48 for the drive of the blower 46 in the embodiment shown. Alternatively, a radial blower or another suitable design can also be used. The driving motor 48 can optionally be connected with the blower 46 via a drive belt or a gear or via a direct axial connection. As recognisable from FIG. 2, an air intake filter 50 is arranged upstream of the blower 46, whereby the air intake filter 50 filters the intaked air and can serve as an intake silencer or being connected with an additional intake silencer if necessary. Within the air feed pipe 44 close to the blower 46 a sensor (not shown) is arranged. The sensor measures the pressure difference between the surrounding area and the excess pressure existing inside the air feed pipe 44 and sends an output signal to a control unit for the driving motor 48. By using such a control unit, even with a decreasing transmissibility of the air intake filter 50, the resulting power of the blower 46 can be kept constant at least as long as the driving motor 48 reaches its capacity by increasing the rotational speed.

The air flow generator 34 is separated from the air discharge duct 36 by a vertical separating plate 52, whereby the air discharge duct 36 is provided with a lower opening 54 which breaks through the horizontal separating plate 32 and which provides an open air compound to the middle segment with the drying nozzles 40, 42.

The longitudinal embodiment of FIG. 4 shows the air discharge duct 36 of the drying module 10, whereby the air discharge duct 36 is formed as a sound silencer. On two vertical side walls 56 of the air discharge duct 36, which are opposing each other, sound absorbing elements 58 are arranged, which are provided by structured plates 60 inclined to the longitudinal direction of the air discharge duct 36. In the embodiment shown, the plates 60 have coarse metal lattices 62 and an infill 64 with metal wool. The sound absorbing effect results for this reason both from a reflexion damping by redirecting the discharging air and an absorption damping by the metal wool. If necessary, the inner walls of the air discharge duct 36 can have additionally a structured surface and/or be lined with sound absorbing material.

In a cover plate 66 of the air discharge duct 36, an additional air discharge is provided, for example, by one or two suction blowers 68. The top view of FIG. 5 shows an embodiment of the air discharge duct 36, which is provided with two suction blowers 68.

As clarified on the basis of FIGS. 1 to 3, the drying modules 10 of the apparatus 12 for drying articles can alternatively be supported on the bottom via vertical supports 70 as well as via height adjustable bases 72 if necessary. The supports 70 form advantageously a supporting frame, which is stabilized by means of crossbars with which the side walls are held. As a matter of course, the housings 14 of the drying modules 10 can be designed in a different way as shown. As clarified on the basis of FIG. 2, the largely similar assembled drying modules 10 can be provided with different air nozzle arrangements 40. In this way, the second drying module 10b comprises a third air nozzle arrangement 74, which blows off the bottles 30 from the bottom. The third drying module 10c is provided with a fourth air nozzle arrangement 76 as well as with a fifth air nozzle arrangement 78. While the fifth air nozzle arrangement 78 corresponds in assembly and its positioning nearby the outlet opening 20 for the conveyor belt 16 and the bottles 30 with the first air nozzle arrangement 40, the fourth air nozzle arrangement 76, which is running inclined upwards and having narrow air nozzles, is provided for blowing off the bottles 30 from the bottom up. On the other hand, an air lock 22 is arranged at the outlet opening 20 (see FIG. 1).

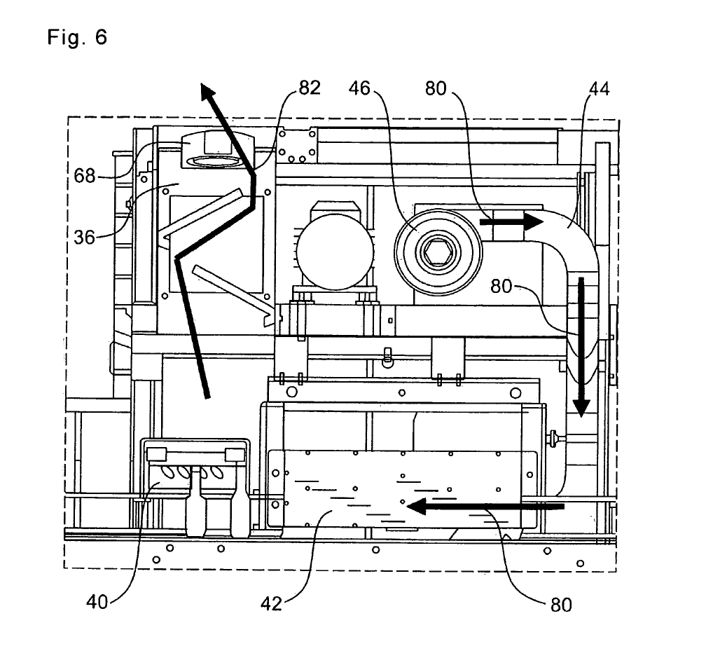

The schematic view of FIG. 6 shows the direction of the air flow within one drying module 10, which describes a circular flow in direction to the air discharge duct 36 starting from the blower 46 via the air feed pipe 44 and the second air nozzle arrangement 42. The redirection of the flow upwards in direction of the air discharge duct 36 is being benefited on the one hand by the exhausting air at the first air nozzle arrangement 40.

Since the first air nozzle arrangement 40 is arranged directly underneath the air discharge duct 36 and since the air of the nozzles is running out inclined upwards, the discharged air from the second nozzle arrangement 42, too, is being routed in the area above the conveyor belt 16 to the left in direction to the first air nozzle arrangement 40 and from there upwards in direction to the air discharge duct 36. The described air flow is additionally supported by the sucking blower 68 which is arranged at the air outlet of the air discharge duct 36 and which transports the humid outlet air upwards out of the housing of the apparatus 12 for drying articles. In the embodiment of FIG. 6, the reference number 80 refers to the drying air being transported by the blower 46 through the air feed pipe to the air nozzle arrangements 40, 42, while reference number 82 refers to the humid outlet air being transported through the air discharge duct 36. The shown direction of the air flow provides that only a very little portion of the humid outlet air 82 leaks through the inlet opening 18 or through the outlet opening 20. The sound absorption is optimized thereby that the predominant portion of the humid outlet air 82 is being discharged to the outside through the air discharge duct 36 which is formed as a sound silencer.

The present invention has been described with respect to preferred embodiments. It is conceivable for a skilled person to carry out amendments or changes of the present invention without departing from the scope of the claims below.

What is claimed is:

1. An apparatus for drying articles comprising:
a closed housing with at least one chamber equipped with air nozzles;
an inlet opening and an outlet opening for the articles to be dried;
at least one air inlet opening for the supply of drying air and at least one air outlet opening for discharging humid exhaust air out of the housing;
an inner routing of air flow inside the housing for generating a defined removal of air to the at least one air outlet opening, wherein the inner routing of air flow has a flow which is directed past the inlet opening and/or the outlet opening for the articles to be dried.

2. The apparatus according to claim 1, wherein the at least one air outlet opening is formed as an air discharge duct and wherein the air discharge duct is constructed as a reflexion and/or as an absorption silencer having sound absorbing elements arranged in the air discharge duct.

3. The apparatus according to claim 2, wherein the sound absorbing elements are of at least one structured plate with metal wool and wherein at least one structured plate is arranged inclined to a longitudinal direction of the air discharge duct.

4. The apparatus according to claim 3, wherein two or more structured plates are consecutively arranged inclined to the longitudinal direction of the air discharge duct.

5. The apparatus according to claim 1, wherein blowing nozzles with an exhausting direction geared to the air discharge duct are arranged within the housing near by the inlet opening and/or the outlet opening for the articles.

6. The apparatus according to claim 1, wherein the housing is provided with elements for air sound absorption and/or body sound absorption.

7. The apparatus according to claim 1, wherein the apparatus is of a modular assembly having a plurality of consecutively arranged drying modules, which are connected with each other, wherein in a feeding direction of the articles a first drying module with the inlet opening for the articles and nozzles respectively is provided for a drying of a lateral area of the articles, wherein in feeding direction of the articles a second drying module is provided with nozzles for drying the bottom of the articles and wherein in feeding direction of the articles a third drying module is provided with the outlet opening and nozzles for drying the lateral area of the articles.

8. The apparatus according to claim 1, wherein at least one air flow generator is provided by means of a blower which is positioned either inside the housing or at said housing or separated from the apparatus for drying articles and wherein the blower is provided with an air intake filter and/or an intake silencer.

9. The apparatus according to claim 8, wherein a pressure sensor is provided after the blower which is suitable for detecting a delivery pressure in an air feed pipe (44).

10. The apparatus according to claim 1, wherein an outlet air silencer is positioned either at the housing or separately from said housing and is connected with said housing via an air outlet feed pipe.

11. A method for drying articles, comprising the steps of:
providing air nozzles inside of a largely closed housing wherein said air nozzles blow air at the articles to be dried;
supplying drying air via at least one air inlet opening;
discharging the air via at least one air outlet opening out of the housing;
generating an inner routing of air flow inside the housing, wherein the air flow is generated by means of a blower which is positioned either inside the housing or at said housing and thereby generating a defined removal of air to the at least one air outlet opening; and
directing exhaust air basically past the inlet opening and/or the outlet opening for the articles to be dried.

12. The method according to claim 11, wherein the exhaust air is routed through at least one air outlet opening which is formed as a sound absorbing air discharge duct.

13. The method according to claim 11, wherein the blowing nozzles, which are positioned within the housing (14) near by the inlet opening and/or the outlet opening for the articles, provide exhaust air geared to the air discharge duct.

14. The method according to claim 11, comprising the step of detecting a delivery pressure within the air feed pipe after the blower.

15. The method according to claim 14, wherein a varying delivery pressure of the blower is counteracted by adjusting the power of the blower.
